(19) United States
(12) Patent Application Publication
(10) Pub. No.: US 2007/0050431 A1
(43) Pub. Date: Mar. 1, 2007

(54) Deploying content between networks

(75) Inventors: Gautam Vishwas Vaidya, Redmond, WA (US); James S. Masson, Seattle, WA (US); Patrick J. Simek, Redmond, WA (US); Rebecca WaiMan Chan, Kirkland, WA (US); Viktoriya Taranov, Bellevue, WA (US); Ziyi Wang, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/213,096

(22) Filed: Aug. 26, 2005

(51) Int. Cl. G06F 17/30

(52) U.S. Cl. 707/204

(57) ABSTRACT

A system to deploy content from one network to another includes an export search component. During an export process, a level-based scan of a content database is performed to efficiently find children and dependencies of the object(s) to be deployed. An export object table is created and filled with the children and dependencies found in the level-based scan. The export object table is ordered based on object type so that for each object being exported, its parent and its dependencies will be exported before the object itself is exported. The system may selectively perform incremental deployments in which only objects that have changed since their last deployment will be exported. Objects have identifiers and the system maintains a change log using the object identifiers, which allows the system to determine whether an object should be included in the incremental deployment.

### BACKGROUND

Content to be published can be created by authors on one network (e.g., an authoring network) and then moved to another network (e.g., a perimeter network) where the content can be accessed by others. Typically, the client is significantly involved in the movement of the content from the authoring network to the perimeter network. Also, content may include objects that have links or references to other objects or resources, which should be correctly deployed along with the content to be deployed. This background information is not intended to identify problems that must be addressed by the claimed subject matter.

### SUMMARY

This summary is provided to introduce a selection of concepts in a simplified form that are further described below in the Detail Description Section. This summary is not intended to identify key features or essential features of the claimed subject matter, nor is it intended to be used as an aid in determining the scope of the claimed subject matter.

According to aspects of various described embodiments, a system to deploy content from one network to another includes an export search component. During an export process, a level-based scan of a content database is performed to efficiently find children and dependencies of the object(s) to be deployed. In one implementation, an export object table is created and filled with the children and dependencies found in the level-based scan. The export object table can be a temporary table in some implementations.

In another aspect, the export object table is ordered based on object type so that for each object being exported, its parent and its dependencies (if any) will be exported before the object itself is exported. This aspect enables each object to have the correct references to its parents and resources.

In yet another aspect, the system may selectively perform incremental deployments in which only objects that have changed since a specified time (e.g., the time of the last deployment) will be exported. In one implementation, objects have identifiers and the system maintains a change log using the object identifiers, which allows the system to determine whether an object that is part of a deployment request should be exported.

In still another aspect, during an export operation, content to be exported is cached by object type, which can improve the efficiency of the export process. For example, instead of accessing the content database once for each object, the system may retrieve a relatively large number of objects of the same type in one access by inspecting the export object table.

In a further aspect, the system includes a dependency list to which users can add identifiers of resources that the users have selected for deployment. This aspect is used to provide a clear dependency mapping of dependency content to primary content. This aspect can advantageously provide a clear configuration for users when creating content and also provides a clear mechanism for the export process to effectively include necessary dependent objects.

In a still further aspect, an object that is imported may be deployed in the destination with a parent that is different from the object's parent in the source (also referred to herein as re-parenting). This aspect may be advantageously used in scenarios in which the user exports an object that is at a branch of a tree without exporting the object's parent (also referred to herein as cherry picking). The user may then re-parent the object by selecting an object in the destination network as the object's parent.

Embodiments may be implemented as a computer process, a computer system or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a block diagram representing an exemplary system that supports deployment of content between networks, in accordance with an embodiment.

FIG. 2 is a representation of data structures used in deploying content between a source and a destination, in accordance with an embodiment.

FIG. 3 is a block diagram representing various components of a deployment system, in accordance with an embodiment.

FIG. 4 is a diagram representing a hierarchy of content elements, in accordance with an embodiment.

FIG. 5 is a diagram illustrating an example of content elements and their dependencies, in accordance with an embodiment.

FIG. 6 is a flow diagram representing operational flow in exporting content to a destination, in accordance with an embodiment.

FIG. 7 is a flow diagram representing operational flow of creating and filling an export object table, in accordance with an embodiment.

FIG. 8 is a diagram illustrating an example of the objects being selected by level to populate the export object table, in accordance with an embodiment.

FIG. 9 is a diagram illustrating an example export object table, in accordance with an embodiment.

FIG. 10 is a flow diagram representing operational flow of formatting content for export, in accordance with an embodiment.

FIG. 11 is a flow diagram representing operational flow in importing content from a source, in accordance with an embodiment.

FIG. 12 is a flow diagram representing operational flow in resolving a conflict in the destination of the import process, in accordance with an embodiment.

### DETAILED DESCRIPTION

Various embodiments are described more fully below with reference to the accompanying drawings, which form a part hereof, and which show specific exemplary embodiments for practicing various embodiments. However, other embodiments may be implemented in many different forms and should not be construed as limited to the embodiments set forth herein; rather, these embodiments are provided so that this disclosure will be thorough and complete. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

Exemplary Content Deployment System

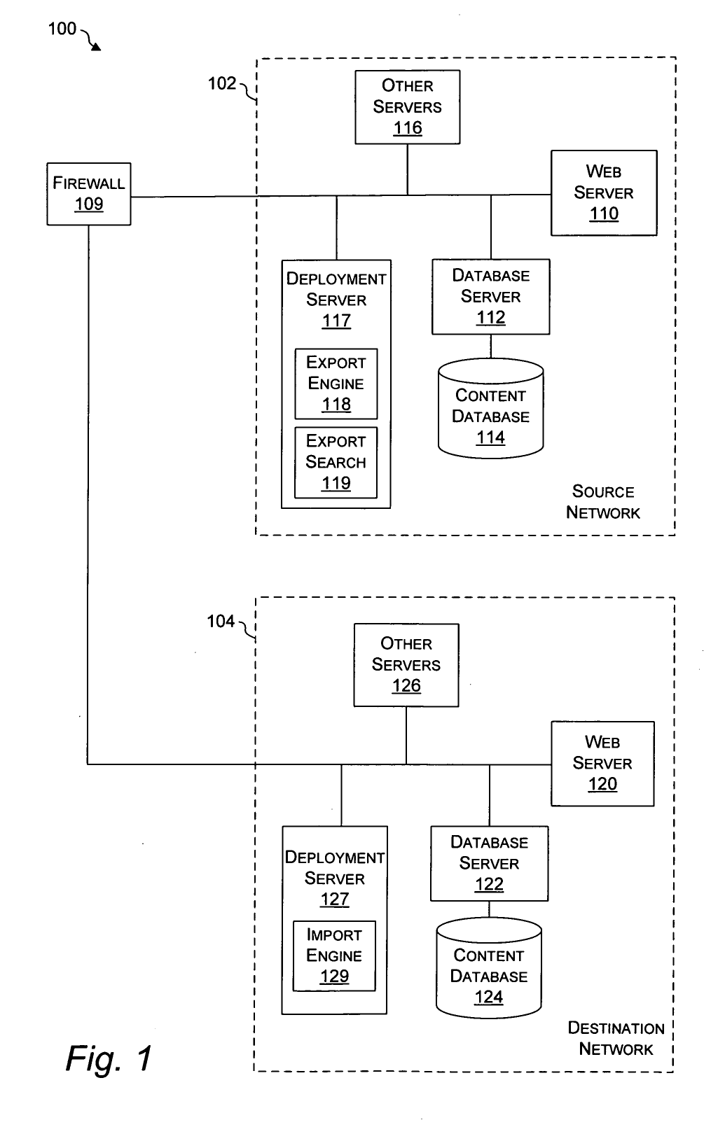

FIG. 1 illustrates a system 100 that supports deployment of content between networks, in accordance with an embodiment. In this exemplary embodiment, system 100 includes a source network 102 and a destination network 104. In some embodiments, source network 102 and destination network 104 are independent server farms. Content authored in source network 102 can be deployed to destination network 104 for access via an external network (not shown) such as, for example, the Internet.

Further, in this embodiment, system 100 includes a firewall 109 coupled between source network 102 and destination network 104, which may be omitted in some embodiments.

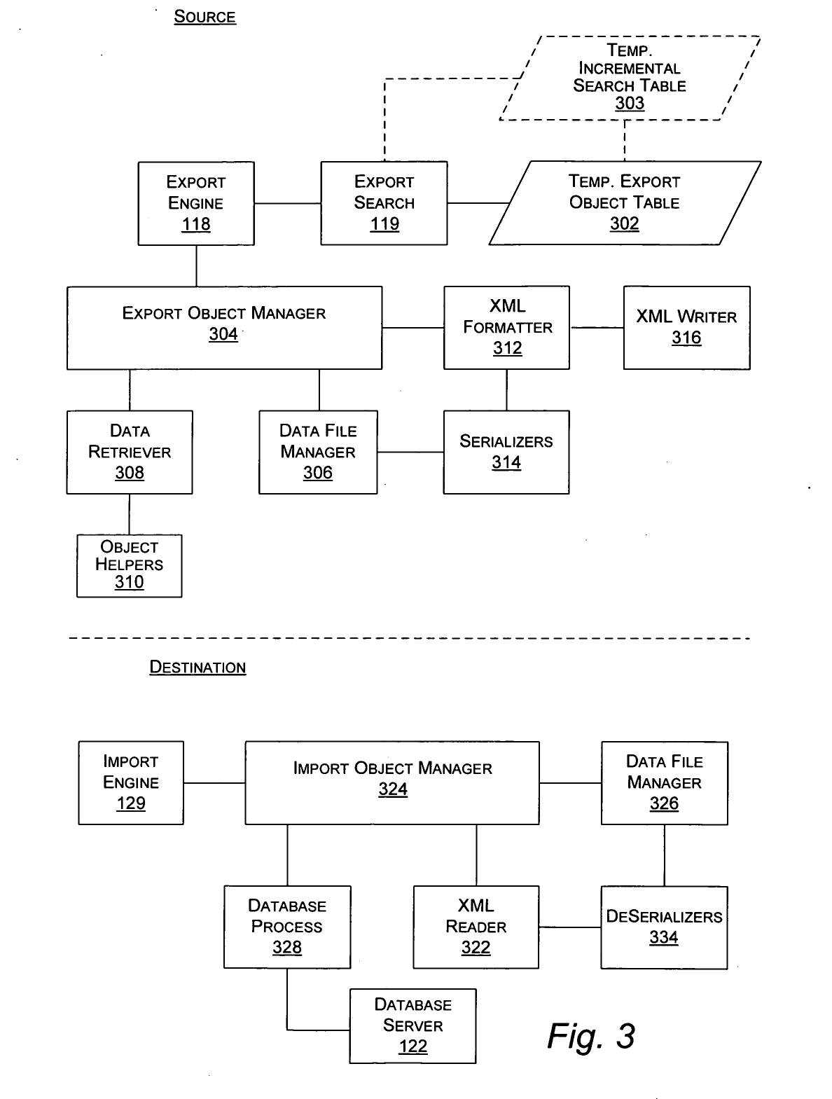

Source network 102, in this embodiment, includes a web server 110, a database server 112, a content database 114, other servers 116 and a deployment server 117, which includes an export engine 118. In this embodiment, data base server 112 includes an export search component 119. Content to be deployed to destination network can be stored in content database 114. In one embodiment, content database 114 is a SQL database, although other suitable relational databases can be used in other embodiments. In some embodiments, other servers 116 include one or more of an application server, a domain controller server, operations management servers, backup servers, etc., that are typically used in server farms. In accordance with this embodiment, deployment server 117 supports a content deployment feature that exports content to another network (e.g., destination network 104) along with the content's dependencies (if any). In this embodiment, export search component 119 that given one or more objects to be deployed, searches content database 114 for children of the objects, and dependencies of the objects and their children. Exemplary components to implement one embodiment of the deployment feature are described below in conjunction with FIG. 3.

Destination network 104, in this embodiment, includes a web server 120, a database server 122, a content database 124, other servers 126, and a deployment server 127, which includes an import engine 129. Web server 120, database server 122, content database 124 and other servers 126, in one embodiment, are similar to previously described web server 110, database server 112, content database 114, and other servers 116. In this embodiment, deployment server 127 is similar to deployment server 117 of source network 102 except that deployment server 128 performs and import operations that correspond to the export operations performed by deployment server 118.

The deployment feature is advantageously used to provide mainly server-side operations that efficiently deploy content and dependencies from a source to a destination. In one embodiment, during an export process, export search component 119 performs a level-based scan of content database 114 to efficiently find children and dependencies of the object(s) to be deployed. In one embodiment, an export object table (e.g., see FIG. 3) is created and filled with the children and dependencies found in the level-based scan. The export object table can be a temporary table in some embodiments.

In some embodiments, export search component 119 orders the export object table based on object type so that for each object being exported, its parent and its dependencies (if any) will be exported before the object itself is exported. The content is then formatted, packaged and transmitted to destination network 104 in this order. This order allows destination network 104 (e.g., deployment server 127) to deploy each object with the correct references to its parents and resources residing on the destination network.

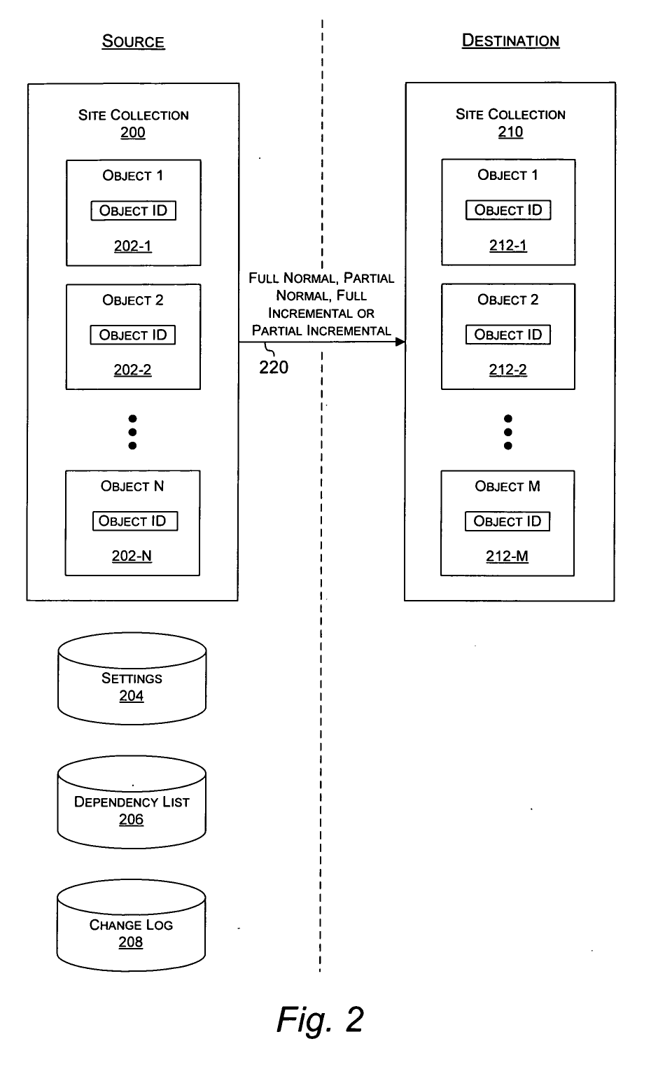

In some embodiments, deployment server 117 allows users to selectively perform incremental deployments in which only objects that have changed since their last deployment will be exported. In one implementation, objects have identifiers and system 100 maintains a change log (e.g., see FIG. 2) using the object identifiers, which allows system 100 to determine whether an object that is part of a deployment request should be exported.

In some embodiments, during an export operation, deployment server 117 caches content to be exported by object type, which can improve the efficiency of the export process. For example, instead of accessing content database 114 once for each object to be deployed, deployment server 117 may retrieve a batch (i.e., relatively large number) of objects of the same type from content database 114 in one access by inspecting the export object table.

In some embodiments, system 100 includes a dependency list (e.g., see FIG. 2) to which users can add identifiers of resources that the users have selected for deployment. The dependency list used to limit the number of dependencies that are exported with the content, which might otherwise grow unmanageably large as each dependency may in turn have its own dependencies.

In some embodiments, a user may desire to deploy an object in the destination with a parent that is different from the object's parent in the source (also referred to herein as re-parenting). This aspect may be advantageously used in scenarios in which the user exports an object that is at a branch of a tree without exporting the object's parent (also referred to herein as cherry picking). The user may then re-parent the object by selecting an object in the destination network as the object's parent.

FIG. 2 is a representation of data structures used in deploying content between a source and a destination, in accordance with an embodiment. In this embodiment, the source includes a site collection 200 to be deployed to the destination. In this example, site collection 200 includes objects 202-1 through 202-N, each having a unique or pseudo-unique object identifier (object ID). In addition, the source includes: a settings datastore 204 for storing settings used in exporting operations; a dependency list 206 for listing resources that can be deployed as dependencies for objects that are being deployed; and a change log 208 for storing information regarding when particular content has been added, updated or deleted.

The destination includes a site collection 210 having objects 212-1 through 212-M. In this example, objects from site collection 200 are to be deployed to site collection 210 as indicated by an arrow 220. In this embodiment, the objects may be full deployment, a partial (cherry-pick) deployment, an incremental full deployment, or an incremental partial deployment. Thus, for example, the source may have N objects but the user may deploy M objects (where M may be less than or equal to N in the case of an incremental or partial deployment).

FIG. 3 illustrates various components of source database server 112 (FIG. 1), source deployment server 117 (FIG. 1), destination database server 122 (FIG. 1), and destination deployment server 127 (FIG. 1), in accordance with an embodiment. In this exemplary embodiment, database server 112 creates an export object table 302 used to store object identifiers of objects to be exported during a deployment process. In scenarios in which an incremental deployment is being performed, database server 112 also creates an incremental search table 303 to store object identifiers of objects that have changed since their last deployment.

Exemplary Export Components

In this exemplary embodiment, in addition to export engine 118, source deployment server 117 (FIG. 1) includes an export object manager 304, a data file manager 306, a database data retriever component 308 (also referred to herein as data retriever 308), object helpers 310 (one for each type of object that can be deployed), an XML formatter 312 (or other formatter in other embodiments), serializers 314 (one for each type of object to be deployed) and an XML writer 316. These components are described below.

Export engine 118, in one embodiment, receives settings (e.g., see FIG. 2) that are used in the export process. For example, the settings can include settings for how to deal with security features, meta-data (e.g., data regarding authorship of the content), sizes of batches of data retrieved from the content database, etc. In one embodiment, export engine 118 is part of a public object model to communicate with external elements (e.g., destination deployment server 127).

Export search component 119, in one embodiment, creates export object table 302 and populates the table with object identifiers of the content to be deployed, along with the dependencies, if any, of the identified objects. For example, if a site collection is to be fully deployed (i.e., all of the objects in the site collection and their dependencies) to destination network 127, export search component 119 would scan content database 114 (FIG. 1) using a level based search algorithm to find the identifier (e.g., object ID) of the specified site collection, and add the identifier in export object table 302. Then export search component 119 scans content database 114 for the identifiers of the children of the site collection (e.g., webs) and adds them to export object table 302. Then export search component 119 scans content database 114 for the identifiers of the children of the children (e.g., lists), and add them to export object table 302. This process continues until all of the children are determined and their identifiers added to export object table 302. In one embodiment, export search component 119, in recursively filling export object table 302, determines whether an object has already been referred during the search and if so, moves to another object to avoid entering an “endless loop”. In accordance with one embodiment, the level-based database search performed by export search component 119 will generally be faster than walking each down the tree structure of the site collection.

Export search component 119, in one embodiment, then searches the content database for dependencies of the objects listed in export object table (including the children) and adds identifiers for these dependencies to export object table 302. As previously mentioned, dependencies include resources such as graphics, links, charts, pictures, icons, etc. that are used in or referenced by objects to be deployed. FIG. 5 illustrates an example of dependencies in which folder objects have icon dependencies of object type list that have been selected to be displayed when the folders are to be represented (for example) in a user interface. In this example, file 1 of the folder object is a word processor file having an icon item doc.ico of type list as a dependency object. Similarly, file 2 of the folder object is a file of custom application called foo having an icon item foo.ico as a dependency object.

In one embodiment, export search component 119 determines whether the dependencies are listed in a dependency list (e.g., see FIG. 2) and only add the identifiers of dependencies listed in the dependency list to the export object table. In one embodiment, users can select which dependencies to add to the dependency list.

Export search component 119, in one embodiment, then orders the export object table. In one embodiment, the order is based on object type so that for each object being exported, its parent and its dependencies (if any) will be exported before the object itself is exported. The content is then formatted, packaged and transmitted to the destination in this order. This order allows the destination (e.g., deployment server 127) to deploy each object with the correct references to its parents and resources residing on the destination.

In another example, if the site collection is to be incrementally deployed (i.e., only objects that have changed since their last deployment), export search component 119 creates and fills incremental search table 303. In one embodiment, export search component 119 searches a change log (e.g., see FIG. 2) using object identifiers of the objects to be incrementally deployed (which stores timestamps of when objects have been last deployed along with the object identifiers). In addition, in one embodiment, each object to be deployed can include metadata that indicates a timestamp of when that object was last updated. In one embodiment, if the “last update” timestamp of an object to be deployed is more recent than the timestamp of that object in the change log, then that object's identifier is added to incremental search table 303. The object identifiers listed in incremental search table 203 is then used to seed export object table 302. Export search component 119 then finds the dependencies of these objects and then adds their identifiers in export object table 302, and then orders the table, as described above.

In some scenarios, a user may wish to deploy only a portion of the site collection rather than the full site collection as describe above. Export search component 119, in one embodiment, can “seed” export object table 302 with only the selected object or objects. Export search component 119 searches for children and dependencies of the object(s) and adds those that are listed in the dependency table to export object table 302. In some embodiment, a user may set a setting in an object to be exported to include no children, a specified level of children, or all children in the export.

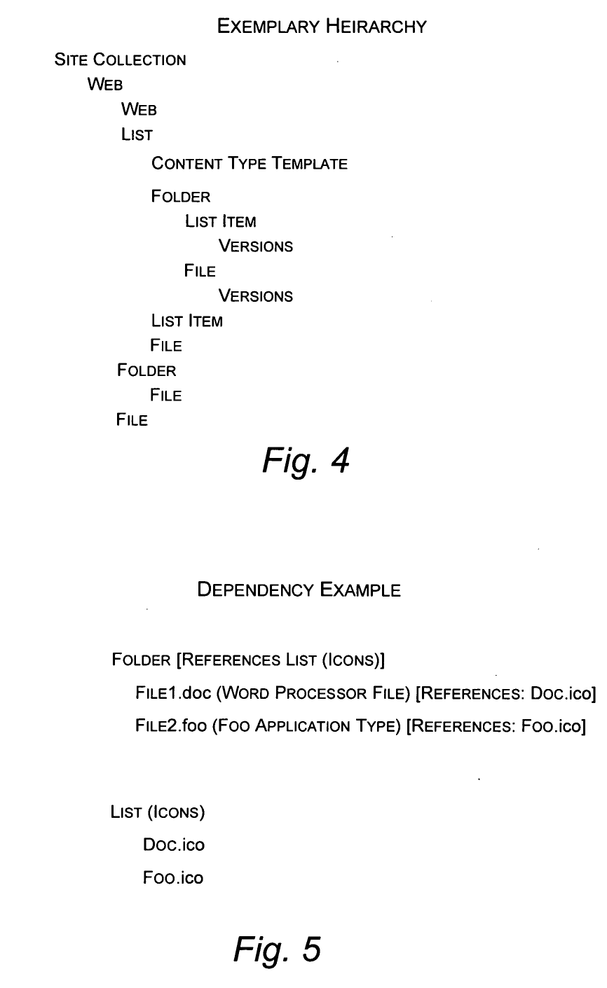

Export object manager 304, in this embodiment, manages the retrieval of objects from content database 114 (FIG. 1). For example, export object manager 304 uses data retriever 308 to receive batches of objects from content database 114. In one embodiment, the number of objects in a batch can depend on the object type. The object types are illustrated in FIG. 4. In this embodiment, objects types are hierarchically defined as site collection, web, subweb, content type template (used to specify a structure for list items), list, folder, list item and version (which can be enabled and disabled in this embodiment). For example, for objects that are of type list, data retriever 308 may retrieve one hundred lists in a batch.

Although an exemplary hierarchy is shown in FIG. 4, in other embodiments different hierarchies that may include fewer or more object types. Further, in some embodiments different terminology may be used for the object types. For example, in some embodiments adopting the naming conventions of WSS (Windows Sharepoint Services developed by Microsoft Corporation, Redmond, Wash.), objects of the type “site” correspond to “web” objects (FIG. 4).

Further, in this embodiment, data retriever 308 uses object helpers 310 to retrieve and cache the objects. As previously mentioned, object helpers 310 include an object helper for each object type. For example, in retrieving web objects from content database 114 (FIG. 1), a web object helper retrieves a batch of web objects listed in export object table according to the order determined by export search component 119. The web object helper caches the batch of web objects, which can then be retrieved as needed for formatting.

Data file manager 306, in this embodiment, reads objects from the object helper caches in the order determined by export search component 119. In this embodiment, data file manager 306 then uses serializers 314 to transform the objects into an intermediate format that can be formatted into XML by XML formatter 312. In other embodiments, the intermediate format allows different formatters to be used instead of XML formatter 312 so that the objects can be formatted into a different format. As previously mentioned, serializers 314 include a serializer for each type of object to be deployed. For example, in some embodiments adopting the naming conventions of .Net framework (developed by Microsoft Corporation, Redmond, Wash.), serializers 314 transform the objects using a special serializer (e.g., a “SerializationInfo” class).

Export object manager 304, in one embodiment, then uses XML formatter 312 to format the serialized output of serializer 314 into XML documents. XML writer 316 then collects the XML documents for multiple objects and combines them into a single XML document. In some embodiments a manifest generated by the XML formatter may be split into multiple files to help optimize transfers.

Data file manager 306, in one embodiment, optionally compresses the resulting XML document using a compressor component (not shown) for transfer to the destination. In some embodiments, other data to be included in the exported package may be compressed along with the XML document.

Exemplary Import Components

In this exemplary embodiment, in addition to import engine 129, destination deployment server 127 (FIG. 1) includes an import object manager 324, a data file manager 326, an XML reader 322 (or reader of other formats in other embodiments), and deserializers 334 (one for each type of object to be deployed). Further, in this embodiment, destination database server 122 (FIG. 1) includes a database process component 328. These components are described below.

Import engine 129, in this embodiment, receives import settings (e.g., see FIG. 2) that are used in the import process. For example, the settings can include settings for how to deal with security features, meta-data (e.g., data regarding authorship of the content), etc. In one embodiment, import engine 118 is part of a public object model to communicate with external elements (e.g., source deployment server 117).

Import object manager 324, in this embodiment, manages the storage of content received from a source (e.g., source network 102 of FIG. 1) into content database 124 (FIG. 1). For example, import object manager 324 uses XML reader 322 to receive XML documents. In one embodiment, data file manager 326 may use a decompressor component (not shown) to decompress any compressed XML documents.

Data file manager 326, in this embodiment, shreds a received XML file into “sub-documents” based on object type. Further, data file manager 326, in this embodiment, inspects the XML sub-documents and from information contained therein causes the appropriate deserializers 324 to reform the XML sub-documents into the originating objects. Because the objects were ordered by export search component 119 (as described above), the objects can be written to destination content database 124 in the same order as received without breaking the dependencies are parent-child references.

Database process 328, in this embodiment, determines whether an object to be written into destination content database 124 already exists. If the object already exists, database process 328 (via import object manager 324) may cause the user to be prompted for instructions for handling the conflict. For example, the user may be prompted to select one of several actions such as: (1) do not import the object; (2) overwrite the object; (3) create a new version of the object, etc.

Data file manager 326, in one embodiment, can then cause an object (after conflict resolution) to be stored in destination content database 124 after being renamed to reflect deployment in the destination. As previously mentioned, in some scenarios, the content to be deployed may be cherry picked. In such scenarios, the object's parent may not have been part of the deployment. Data file manager 326 (via import object manager 324) may then re-parent the object (i.e., specify an object residing in the destination as the parent for the object). For example, in some embodiments the user performing the deployment can add re-parenting information in the package being imported.

Exemplary Source Operational Flow in Deploying Content

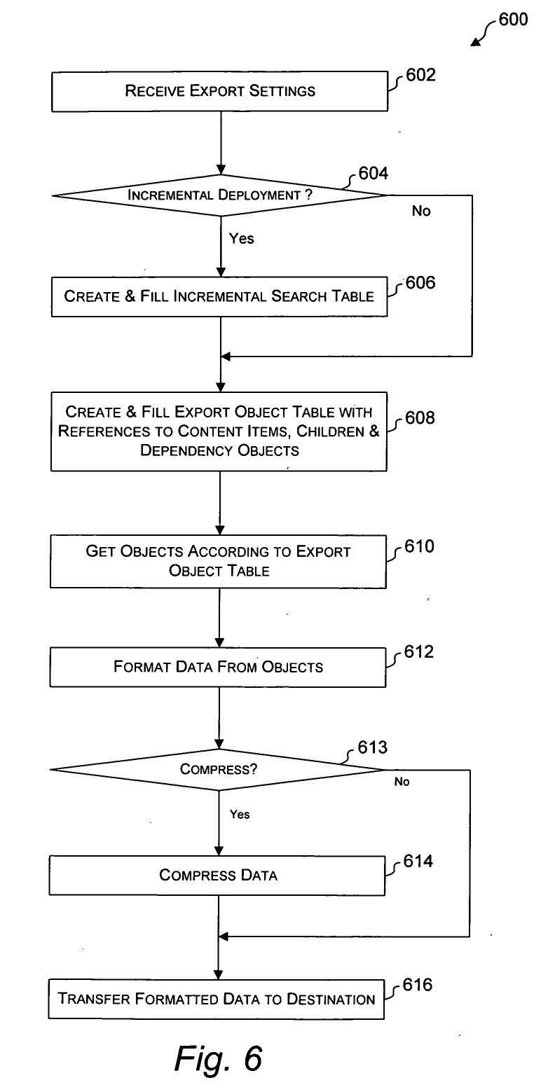

FIG. 6 illustrates an operational flow 600 in exporting content to a destination, in accordance with an embodiment. Operational flow 600 may be performed in any suitable computing environment. For example, operational flow 600 may be executed by a system such as the source illustrated in FIG. 3. Therefore, the description of operational flow 600 may refer to at least one of the components of FIG. 3. However, any such reference to components of FIG. 3 is for descriptive purposes only, and it is to be understood that the implementations of FIG. 3 are a non-limiting environment for operational flow 600.

At block 602, export settings are received by a source. In one embodiment, the export settings are provided by an operator and stored in a preselected location (e.g., within the package being exported, in a datastore, etc.). An operator can be, for example, a central administrator, a site collection administrator, a web administrator (for web services embodiments). These export settings can include settings for how to deal with security features, meta-data (e.g., data regarding authorship of the content), package size (the size of packages used to move data from the source to the destination), versioning, etc. In one embodiment, an export engine such as export engine 116 (FIG. 3) receives the settings from the settings datastore.

At block 604, it is determined whether the content to be deployed is to be an incremental deployment. In this embodiment, the deployment can be either a normal deployment (in which objects are exported even if they have not changed since their last deployment) or an incremental deployment (in which only objects that have changed since their last deployment are exported). Normal and incremental deployments are each further classified as a full deployment (in which the objects and all of their children are exported) or a partial deployment (i.e., in which a user selects particular object(s) for export). In one embodiment, a component such as export object manager 304 (FIG. 3) determines whether the deployment is to be an incremental deployment. If it is determined that the deployment is not to be an incremental deployment, operational flow 600 can proceed to block 608. Otherwise, operational flow proceeds to block 606.

At block 606, an incremental search table is created and filled. In one embodiment, a database component such as export search component 119 (FIG. 3) creates the incremental search table. In addition, the database component uses a change log (e.g., change log 208 of FIG. 2) to search the content database for objects that have been update since the objects were last exported and adds the identifier of all such objects in the incremental search table. For example, in one implementation each object includes a timestamp indicating when that object was created or updated. The database component can compare this timestamp with the time (as indicated in the change log) that that particular object was last exported and add that object's identifier to the incremental search table if the timestamp is more recent than the last export time indicated in the change log. For normal incremental deployments, all of the objects of the site collection are inspected and compared to the change log. For partial incremental deployments, only the objects specified by the user for the partial deployment are inspected and compared to the change log.

At block 608, an export object table is created and filled. In one embodiment, the aforementioned database component creates a temporary export object table and then fills the table with identifiers of objects and their dependencies (if any) to be deployed. In the case of full normal deployment, the export object table is seeded with an identifier representing the entire site collection to be deployed. In the case of a partial normal deployment, the export object table is seeded with only the identifiers of objects specified by the user. In the case of normal incremental deployment, the export object table is seeded with only identifiers of the objects identified in the incremental search table. In the case of partial incremental deployment, the export object table is seeded with only identifiers of the objects identified in the incremental search table and have been selected been selected by the user for partial deployment.

In one embodiment, in the case of full normal deployments, the database component recursively fills the export object table with the children of the seed objects, whereas for partial deployments, the database component will not search for children of the seed objects.

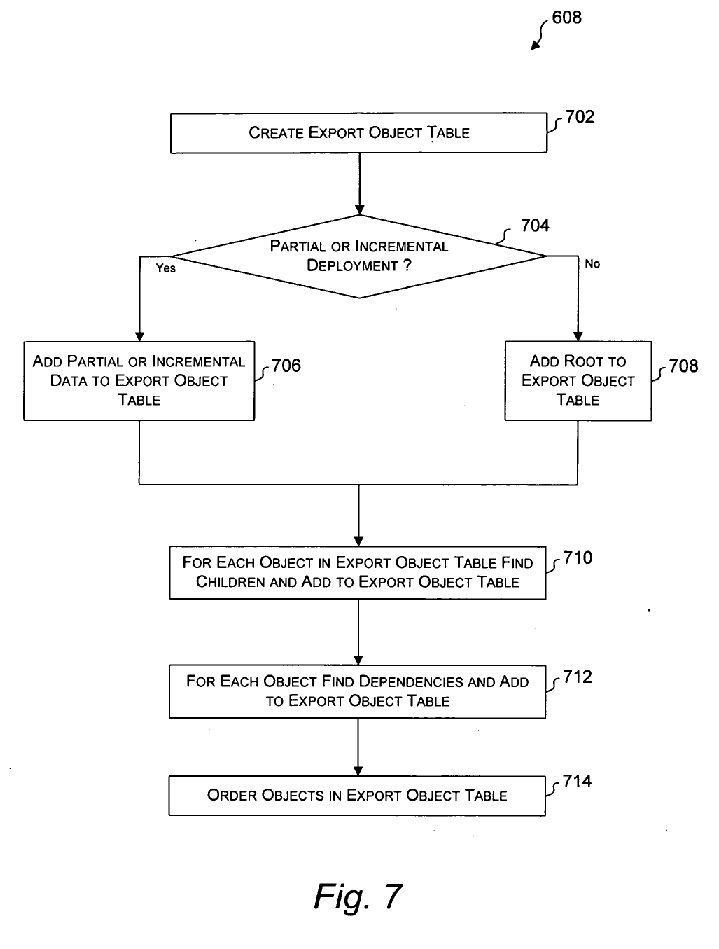

In adding the identifiers of dependencies to the export object table, in one embodiment the database component will compare the dependency identifiers to a dependency list (e.g., dependency list 206 of FIG. 2) and only add those that are on the list. As previously described, users can add identifiers of dependency objects to the dependency list to ensure that the desired dependencies are exported along with the objects. One implementation of block 608 is described in more detail below in conjunction with FIG. 7.

At block 610, objects are retrieved from the content database using the export object table. In one embodiment, objects are retrieved from the content database and cached according to object type. For example, object helpers for each object type (e.g., object helpers 310 of FIG. 3) each inspect the export object table and retrieve a batch of objects and read the objects into memory. This type of access is typically efficiently performed in a relational database and the batching technique can significantly reduce the number of network I/O operations needed to read the objects into memory. In one embodiment, the aforementioned database component uses the object helpers to retrieve the objects to be exported so that cached in each object helper cache in the order specified in the export object table.

At block 612, the retrieved objects are formatted for transfer to the destination. In one embodiment, the objects are retrieved from the object helper caches in the order specified by the export object (e.g., using the order they appear in the caches) and then serialized. For example, the objects can be serialized into an intermediate format using serializers for each object type. A formatting component can then transform the data in the intermediate format into the desired format.

In one exemplary embodiment, a data file manager component such as data file manager 306, in the specified order, causes the appropriate serializer to retrieve objects from the appropriate object helper cache and serialize the object into a SerializationInfo class according to the aforementioned .NET framework. In this exemplary embodiment, a formatting component such as XML formatter 312 (FIG. 3) then process the serialized data to form an XML document for each object. The XML documents can then be combined with other XML documents derived from other objects to be exported into one XML document (e.g., by a writer component such as XML writer 316 of FIG. 3). This XML document can then be packaged and transmitted to the destination. One implementation of block 612 is described in more detail below in conjunction with FIG. 10.

At block 613, it is determined whether the data is to be compressed. In one embodiment, the aforementioned data file manager component determines whether the data is to be compressed by inspecting the export settings received at block 602.

At block 614, the data is compressed using a suitable compression algorithm and formed into a package. In one embodiment, the data file manager uses a compression component that compresses the data into a format such as the cabinet (CAB) file format developed by Microsoft Corporation.

At block 616, the package is transmitted to the destination.

Although operational flow 600 is illustrated and described sequentially in a particular order, in other embodiments, the operations described in the blocks may be performed in different orders, multiple times, and/or in parallel. Further, in some embodiments, one or more operations described in the blocks may be separated into another block, omitted or combined.

FIG. 7 illustrates an operational flow for block 608 (FIG. 6) in filling an export object table, in accordance with an embodiment.

At block 702, the export object table is created. In one embodiment, the aforementioned database component creates the export object table.

At block 704, it is determined whether the deployment is a partial deployment or incremental deployment. If the deployment is a partial deployment or an incremental deployment, the operational flow proceeds to block 706. Otherwise (i.e., a full normal deployment), the operational flow proceeds to block 708.

At block 706, the identifiers of the objects of the incremental or partial deployment are added to the export object table. In one embodiment, the database component seeds the export object table with the identifiers listed in the incremental search table (see block 606 of FIG. 6).

At block 708, the export object table is seeded with an identifier representing the entire site collection to be deployed. In one embodiment, this identifier is of the root object of the site collection.

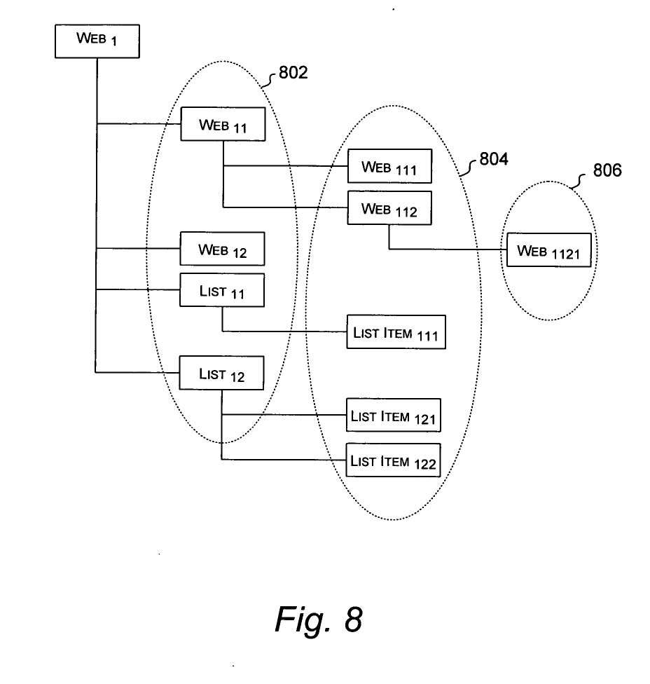

At block 710, the children of each object (e.g., see FIG. 8) in the export object table are found and added to the export object table. In one embodiment, the aforementioned database component will recursively fill the export object table with the children of the objects, using level-based scanning techniques for searching the content database. As previously mentioned, level-based scanning can be significantly less costly in time and resources compared to traversing each object's “tree” of children.

FIG. 8 illustrates the levels of children of an example object. In this example, the “root” object is WEB₁, which has children 802 consisting of objects WEB₁₁, WEB₁₂, LIST₁₁ and LIST₁₂. Children 802 are also referred to herein as the first level. In this example, the first level has a set of children 804 as follows: WEB₁₁ has children consisting of objects WEB₁₁₁, WEB₁₁₂; WEB₁₂ has no children; LIST₁₁ has child LIST ITEM₁₁₁; LIST12 has children LIST ITEM₁₂₁ and LIST ITEM₁₂₂. Children 804 are also referred to herein as the second level. In this example, the second level has a set of children 806 containing only WEB₁₁₂₁, which is a child of WEB₁₁₂. Thus, in a first pass, children 802 are found and their identifiers are added to the export object table. In a second pass, children 804 are found and their identifiers are added to the export object table. In a third pass, children 806 (having only one child in this example) are found and their identifiers added to the export object table. In this embodiment, objects of type list item do not have children. In this embodiment, such searches are recursively performed until all of the children of root object WEB₁ are found and added to the export object table.

Returning to FIG. 7, at block 712, the dependencies of each object in the export object table are found and their identifiers added to the export object table. As previously mentioned, dependencies include resources such as graphics, links, charts, pictures, icons etc. that are used in or referenced by objects to be deployed. In one embodiment, the aforementioned database component finds and lists the dependencies in the export object table. Further, in some embodiments, the identifier of a found dependency is not added to the export object table unless the identifier is listed in a dependency list such as dependency list 206 (FIG. 2). In one implementation, the aforementioned database component determines whether the dependencies are listed in a dependency list and only adds the identifiers of dependencies listed in the dependency list to the export object table.

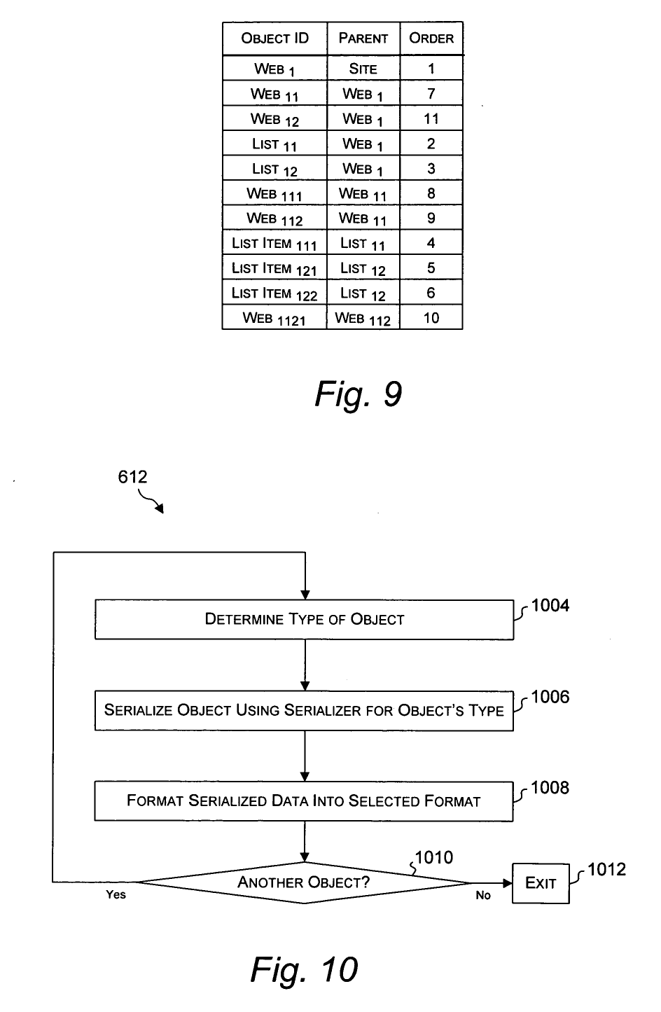

At block 714, objects listed in the export object table are then ordered so that for each object being exported, its parent and its dependencies (if any) will be exported before the object itself is exported. This order helps simplify the import process at the destination in deploying each object with the correct references to its parents and resources residing on the destination network. In one embodiment, the aforementioned database component orders the export object table. An example of how the export object table is ordered is described below in more detail in conjunction with FIG. 9.

Although the operational flow of FIG. 7 is illustrated and described sequentially in a particular order, in other embodiments, the operations described in the blocks may be performed in different orders, multiple times, and/or in parallel. Further, in some embodiments, one or more operations described in the blocks may be separated into another block, omitted or combined.

FIG. 9 illustrating an example export object table corresponding to the export of objects in the example of FIG. 8, according to an embodiment. In this example, the export table (for a particular site collection) is populated so that first entry in the table corresponds to the root object WEB₁. The next four entries in the export object table correspond to the first level children 802. The next five entries in the export object table correspond to the second level children 804. The next entry corresponds to the third level children 806. In this embodiment, the export object table includes a column for identifying an object's parent. Although none are shown in this example, if objects listed in the table had dependencies, the dependency objects would be found and then listed in the export object table. In this embodiment, using each object's object type, parent property and URL, values can be placed in an order column of the export object table that specify the order in which the objects are to be exported.

In this embodiment, the objects are ordered by giving precedence to site objects and then root objects. The root objects can include cherry picked objects. Within each root object, the precedence of objects is folder, file, content type template, list, and list item. Then web objects are ordered by URL. Thus, taking the example tree of FIG. 8, the root objects are given precedence. In this example, the first root object (and only root object in this example) is the root object WEB₁, and thus is given a value of “1” in the export object table.

Then for this root object, the objects are given precedence in the order folder, file, content type template, list, and list item. In this case, there are no folders, files or content type templates, so objects LIST₁₁ and LIST₁₂ are given the values “2” and “3”, respectively, in the export object table. List items are next in this example ordering process, so the objects LIST ITEM₁₁₁; LIST ITEM₁₂₁ and LIST ITEM₁₂₂ are given values “4”, “5” and “6”, respectively, in the export object table.

Then web objects are ordered by URL in this example ordering process. In this example, WEB₁₁ has the next URL after root web object WEB₁ and, thus, is given a value “7”. Within this sub-web, the precedence of folder, file, content type template, list, and list item is applied. In this case, there are no folders, files, content type templates, lists or list items, so the objects WEB₁₁₁ and WEB₁₁₂ are given the values “8” and “9”, respectively.

This process is applied recursively again to each of WEB₁₁₁ and WEB₁₁₂. In this example, WEB₁₁₁ does not have any children so the child of WEB₁₁₂ (i.e., WEB₁₁₂₁) is given the value “10”. Going to the next web URL, web object WEB₁₂ is given the value “11”. The objects are then exported according to these values.

FIG. 10 illustrates an operational flow for block 612 (FIG. 6) in formatting content for export, in accordance with an embodiment.

At block 1004, the object to be exported is inspected to determine the object's type. In one embodiment, the aforementioned data file manager component (e.g., data file manager 306 of FIG. 3) inspects the object from the object helper cache to determine the object type of the next object to be exported. In another embodiment, the object's type is implicitly specified by the object helper cache in which the object resides.

At block 1006, the object is serialized. In one embodiment, the object is serialized using a serializer adapted for the object's type. For example, the serializer may be selected from a group of serializers (e.g., serializers 314 of FIG. 3). As previously described, the object may be serialized into an intermediate format using standard serializers available in the .NET framework.

At block 1008, the serialized data is formatted into a selected format such as, for example, XML. In one embodiment, a formatter such as an XML formatter that processes by the SerializationInfo class according to the .NET framework. If the object is the first object to be serialized in this deployment, this resulting XML sub-document serves as the XML document to be transferred at block 616 (FIG. 6). However, if this object is not the first to be serialized in this deployment, the resulting XML sub-document is then combined with the XML document that contains XML sub-documents previously generated for other objects that were serialized in this deployment.

At block 1010, it is determined whether there is another object to be exported in this content deployment. In one embodiment, the aforementioned data file manager determines whether there is another object to export by inspecting the export object table. If it is determined that another object is to be exported, the operational flow returns to block 1104 to process the next object listed in the export object table. If there are no more objects to be serialized, the operational flow of block 612 exits, as indicated by block 1012.

In some embodiments, the XML document may include security/authentication features such as tokens, digital signatures, etc. to ensure that the deployment is authorized.

Although the operational flow of FIG. 10 is illustrated and described sequentially in a particular order, in other embodiments, the operations described in the blocks may be performed in different orders, multiple times, and/or in parallel. Further, in some embodiments, one or more operations described in the blocks may be separated into another block, omitted or combined.

Exemplary Destination Operational Flow in Deploying Content

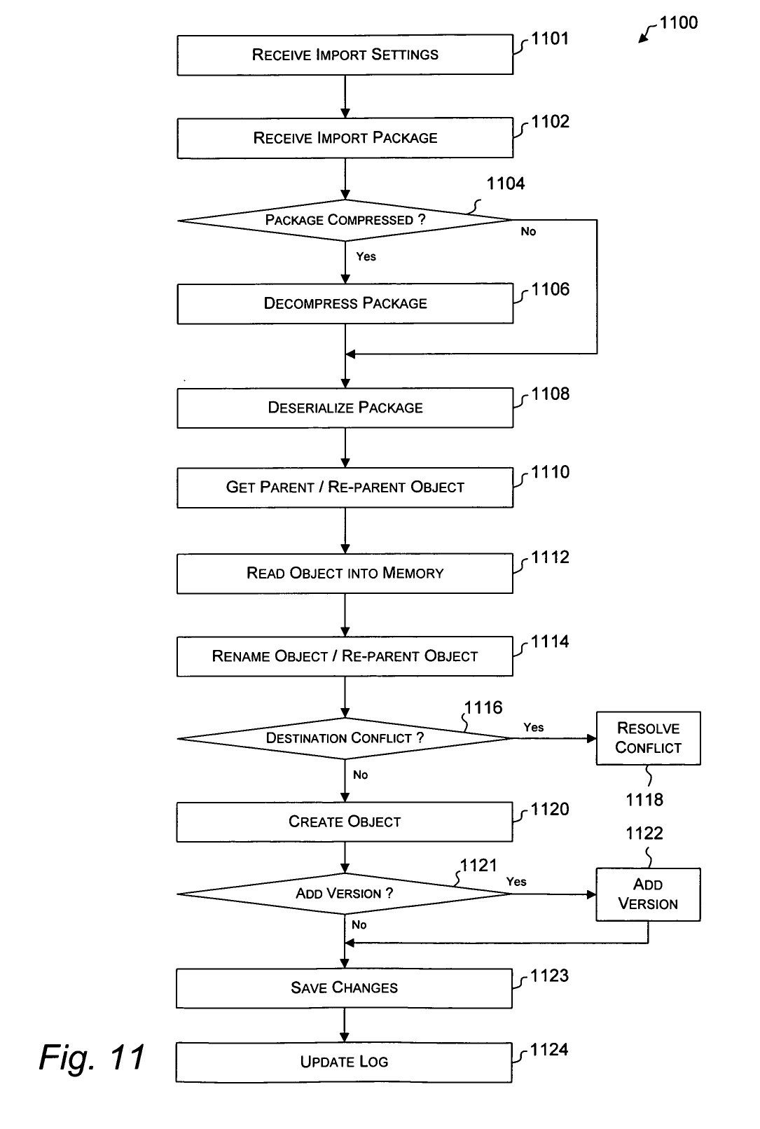

FIG. 11 illustrates an operational flow 1100 in importing content from a source, in accordance with an embodiment. Operational flow 1100 may be performed in any suitable computing environment. For example, operational flow 1100 may be executed by a system such as the destination illustrated in FIG. 3. Therefore, the description of operational flow 1100 may refer to at least one of the components of FIG. 3. However, any such reference to components of FIG. 3 is for descriptive purposes only, and it is to be understood that the implementations of FIG. 3 are a non-limiting environment for operational flow 1100.

At block 1101, import settings are received by a destination. In one embodiment, the import settings are provided by an operator and stored in an import settings datastore (not shown). These import settings can include settings for how to deal with security features (including what type of security information to import), meta-data (e.g., data regarding authorship and editorship of the content), conflict resolution, etc. In one embodiment, an import engine such as import engine 129 (FIG. 3) receives the settings from the destination import settings datastore.

At block 1102, an import package is received. In one embodiment, the import file is transmitted by a source such as the source shown in FIG. 3. In some embodiments, the package is received by a reader component (e.g., such as XML reader 322 of FIG. 3) to begin the process of forming objects from the data contained in the received package. The reader component would correspond to the format used by the source in formatting the data contained in the package. Further, in some embodiments, the import package may be validated using security/authentication features such as tokens, digital signatures, etc.

At block 1104, it is determined whether the received package was compressed. In one embodiment, the aforementioned reader component inspects the extension of the package to determine if the package is a file. If the package is a file, the package is considered to be compressed. On the other hand, if the package contains a directory, then the package is assumed to be uncompressed. If it is determined that the package was not compressed, operational flow 1100 can proceed to block 1108. Otherwise, operational flow 1100 can proceed to block 1106.

At block 1106, the package is decompressed. In one embodiment, the aforementioned formatter component performs the decompression.

At block 1108, the package de-serialized. In one embodiment, a data file manager such as data file manager 326 (FIG. 3) shreds a received decompressed package into constituent “sub-documents” that were combined in forming the package. Further, the data file manage inspects each sub-document and from information contained therein causes an appropriate deserializer (e.g., one of deserializers 324 of FIG. 3) to reform that sub-document into the original object.

At block 1110, in the case of a full deployment scenario, the identifier of the parent object (e.g., a root object at the top of the tree of objects) of the deployment is obtained from the deserialized data. In one embodiment, the aforementioned data file manager gets the identifier of the parent object from deserialized data in full deployment scenarios.

In the case of a partial deployment scenario, the identifier for re-parenting the cherry picked object is obtained from the source or the user initiating the deployment. That is, because a cherry picked object will generally not be the root of the tree of objects and information relating the cherry picked object to its parent on the source is not exported along with the object, re-parenting provides the user a mechanism to specify a parent on the destination side for the cherry picked object. In one embodiment, the aforementioned data file manager gets the identifier of the “re-parent” object from the source. For example, in one embodiment the data file manager may make a callback to the source to obtain the identifier for the “re-parent” object.

At block 1112, each object obtained in block 1108 is read into memory for further processing before storing the object into the destination database. In one embodiment, the aforementioned data file manager causes the objects from block 1108 to be read into memory.

At block 1114, in the case of a full deployment scenario, each object is renamed using the parent identifier obtained at block 1110. In the case of a partial deployment scenario, each object is re-parented using the “re-parent” identifier obtained at block 1110. The renaming/re-parenting reflects the fact that the objects are deployed in another location (i.e., the destination instead of the source). In one embodiment, the aforementioned data file manager performs the renaming/re-parenting.

At block 1116, it is determined whether there is a destination conflict in deploying the objects in the destination. A destination conflict can occur when the object already exists in the destination by inspecting the object identifier of the object to those of objects already created at the destination. In one embodiment, a database process (e.g., such as database process 328 of FIG. 3) determines whether a conflict exists. If it is determined that a conflict exists, operational flow 1100 can proceed to block 1118. If no conflict is found, operational flow 1100 can proceed to block 1120.

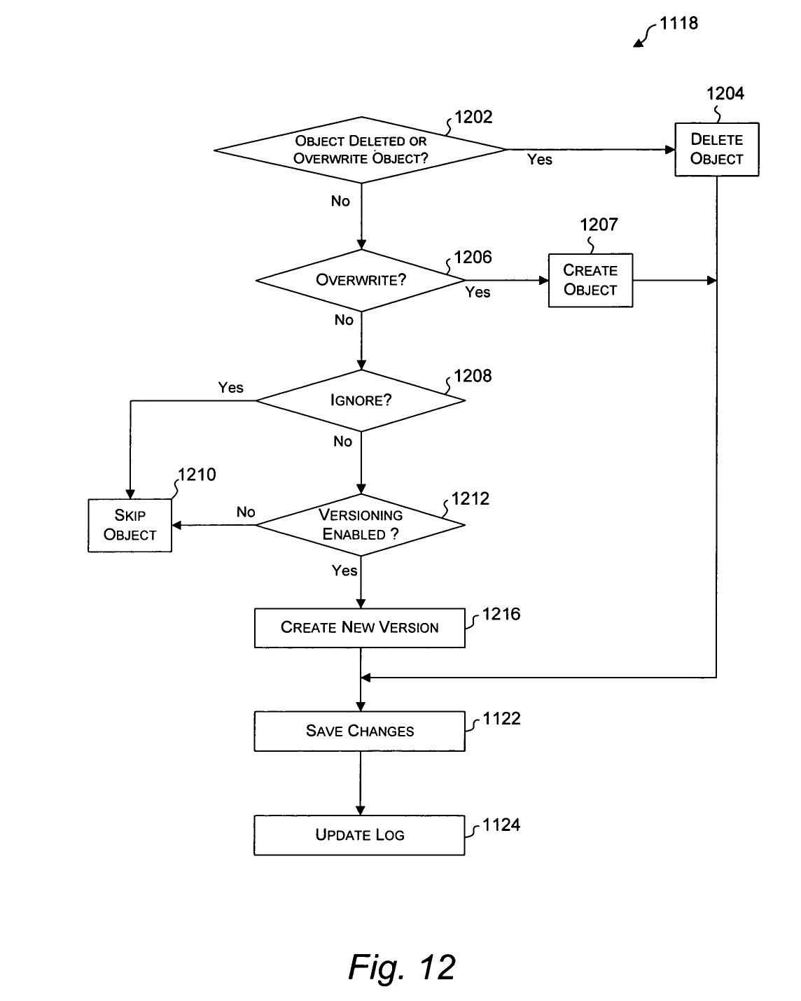

At block 1118, the conflict is resolved. In one embodiment, an import object manager (e.g., such as import object manager 324 of FIG. 3) resolves the conflict. For example, the import object manager may resolve conflicts by overwriting the objects at the destination (i.e., the source “wins”); not deploying the object (i.e., the destination “wins”); creating a new version of the object at the destination, etc. One implementation of block 1118 is described in more detail below in conjunction with FIG. 12.

At block 1120, because the object does not exist at this branch of operational flow 1100, the object is created in the destination. In one embodiment, the aforementioned data file manager in creates the object in the destination by storing the object in destination content database. In addition, in some embodiments, a reference “fix-up” operation is performed so that the references to its dependencies (with regard to their locations in the destination) are correct. In one embodiment, the data file manager performs the reference fix-up operation.

At block 1121, it is determined whether the object should be created with a version indication (i.e., the first version). In one embodiment, versioning can be enabled via the import settings received at block 1101. For example, in some embodiments, the data file manager determines whether the object is of a type that supports versioning (e.g., a document, file) and then determines whether versioning as been enabled (e.g., by inspecting the import settings). Further, in some embodiments, version-capable objects can also have a enable/disable property that can be set by an operator. Thus, in such embodiments, versioning information is added only if the object is version-capable, the object has versioning enabled, and the import settings (e.g., block 1121) have enabled versioning. If it is determined that the object should not be created with a version indication, operational flow 1100 can proceed to block 1124. However, if it is determined that the object should be created with a version indication, operational flow 110 can proceed to block 1122.

At block 1122, version information is added to the object. In one embodiment, the data file manager adds the version information to the object.

At block 1123, changes are saved. In this embodiment, the changes include providing the version indication to the object. In one embodiment, the data file manager causes the changes to the object to be saved.

At block 1124, the change log is updated. In one embodiment, the data file manager updates the change log with the object identifier and time of the object that has been created at block 1120. In one embodiment, each object that is imported updates the change log.

Although the operational flow of FIG. 11 is illustrated and described sequentially in a particular order, in other embodiments, the operations described in the blocks may be performed in different orders, multiple times, and/or in parallel. Further, in some embodiments, one or more operations described in the blocks may be separated into another block, omitted or combined.

FIG. 12 illustrates an operational flow for block 1118 (FIG. 11) in resolving a conflict in the destination of the import process, in accordance with an embodiment. As described above in conjunction with FIG. 11, block 1118 is performed when the object to be deployed already exists at the destination. Thus, if a conflict is identified in the destination with items to be imported from the source package, in one embodiment the operational flow proceeds to block 1202.

At block 1202, it is determined whether the object has been deleted at the destination. In some scenarios, an administrator may want to delete an object from the destination for some reason (e.g., for security, privacy, technical, costs, inaccuracies, a failed previous attempt, etc.) of which the source may not be aware. During an incremental deployment, an object that has been deleted may nevertheless be listed in the incremental search table. In one embodiment, the aforementioned import object manager determines whether the deleted object exists at the destination, the operational flow can proceed to block 1204; if not the operational flow can proceed to block 1206.

At block 1204, the object being imported is deleted. In one embodiment, the import object manager performs this deletion operation. The operational flow can then proceed to previously described blocks 1122 and 1124 (in conjunction with FIG. 11) at which the object is deleted and the change log is updated.

At block 1206, it is determined whether the existing object should be overwritten by the object being imported. In one embodiment, the import object manager performs this overwrite determination. For example, in one implementation the import settings (see block 1101) include an overwrite setting that specifies whether the existing destination object should be overwritten. In another embodiment, the import object manager can cause (via the import engine) a prompt to be displayed to the user on at the source to select whether the object should be overwritten. If it is determined that the existing object should be overwritten, the operational flow proceeds to previously described blocks 1122 and 1124 at which the object is overwritten and the change log is updated. On the other hand, if it is determined that the existing object should not be overwritten, the operational flow proceeds to block 1208.

At block 1208, it is determined whether the object supports versioning. In one embodiment, only objects of type file and document support versioning. In one implementation, the aforementioned import object manager determines whether the object to be imported supports versioning by inspecting the object's object type. If it is determined that the object does not support versioning, the operational flow proceeds to block 1210. However, if it is determined that the object does support versioning, operational flow proceeds to block 1212.

At block 1210, import of the object is skipped. In one embodiment, the import object manager discontinues the process of deploying that particular object. In some embodiments, one or more logs (not shown) may be updated to show that import of the object was skipped.

At block 1212, it is determined whether versioning information should be added to the object. For example, in some embodiments, the data file manager determines whether the object is of a type that supports versioning (e.g., a document, file) and then determines whether versioning as been enabled (e.g., by inspecting the import settings). Further, in some embodiments, version-capable objects can also have a enable/disable property that can be set by an operator. Thus, in such embodiments, versioning information is added only if the object is version-capable, the object has versioning enabled, and the import settings (e.g., block 1121) have enabled versioning. If it is determined that versioning is disabled, the operational flow proceeds to previously described block 1210. However, if it is determined that versioning is enabled, the operational flow proceeds to block 1216.

At block 1216, the object is created as a new version of the existing object. In one embodiment, the aforementioned data file manager in creates the object in the destination by storing the object in destination content database. In addition, in some embodiments, a reference “fix-up” operation is performed so that the references to its dependencies (with regard to their locations in the destination) are correct. In one embodiment, the data file manager also performs the reference fix-up operation. The operational flow then proceeds to previously-described blocks 1122 and 1124 at which a version indication is provided to the object and the change log is updated.

Although the operational flow of FIG. 12 is illustrated and described sequentially in a particular order, in other embodiments, the operations described in the blocks may be performed in different orders, multiple times, and/or in parallel. Further, in some embodiments, one or more operations described in the blocks may be separated into another block, omitted or combined.

Conclusion

Reference has been made throughout this specification to “one embodiment,” “an embodiment,” or “an example embodiment” meaning that a particular described feature, structure, or characteristic is included in at least one embodiment. Thus, usage of such phrases may refer to more than just one embodiment. Furthermore, the described features, structures, or characteristics may be combined in any suitable manner in one or more embodiments.

One skilled in the relevant art may recognize, however, that embodiments may be practiced without one or more of the specific details, or with other methods, resources, materials, etc. In other instances, well known structures, resources, or operations have not been shown or described in detail merely to avoid obscuring aspects of the embodiments.

While example embodiments and applications have been illustrated and described, it is to be understood that the invention is not limited to the precise configuration and resources described above. Various modifications, changes, and variations apparent to those skilled in the art may be made in the arrangement, operation, and details of the methods and systems disclosed herein without departing from the scope of the claimed invention.

What is claimed is:

1. A method for deploying content from a source to a destination, the method comprising:
populating during a first deployment mode an export table with references to:
one or more content items to be deployed, children, if any, of the one or more content items, and dependencies of the one or more content items and children;
getting content items from a content database corresponding to the references stored in the export table; and
formatting data of the content items.

2. The method of claim 1 further comprising determining, for each content item to be deployed, whether the content item was changed since the last time the content item was deployed to the destination.

3. The method of claim 1 further comprising ordering the one or more content items, children and dependencies in the export table.

4. The method of claim 1 wherein formatting data of the content items comprises serializing the content items.

5. The method of claim 4 wherein serializing the content items comprises transforming data of the content items into an intermediate format.

6. The method of claim 5 wherein formatting data of the content items further comprises formatting the data in intermediate format into an XML format.

7. The method of claim 1 further comprising adding a reference to a dependency to the export table in response to a determination that the dependency is listed on a list of deployable dependencies.

8. The method of claim 1 wherein getting content items from the content database comprises getting a batch of content items from the content database.

9. The method of claim 8 wherein the content items of the batch are of a single content type.

10. The method of claim 1 further comprising populating, during a second deployment mode, the export table with references to one or more user specified content items and their dependencies, and not populating the export table with references to children of the one or more user-specified content items.

11. A method for importing content from a source to a destination, the method comprising:
receiving a file from the source and shredding the received file into portions corresponding to content items;
transforming the portions of the received file into content items to be imported into the destination.
determining, for each content item, whether the content item already exists in the destination; and
selectively creating a content item in the destination in response to a determination that the content item did not already exist in the destination.

12. The method of claim 11 further comprising decompressing the received file in response to a determination that the file was compressed by the source.

13. The method of claim 11 further comprising applying a version indication to a created content item in response to a determination that versioning is enabled at the destination.

14. The method of claim 11 further comprising performing a conflict resolution process in response to a determination that a content item already exists in the destination.

15. The method of claim 14 wherein the conflict resolution process comprises selectively overwriting the existing content item with the content item to be imported.

16. The method of claim 14 wherein the conflict resolution process comprises selectively creating a new content item version using the content item to be imported.

17. The method of claim 14 wherein the conflict resolution process comprises selectively discontinuing importation of the content item to be imported in response to a determination that the existing content item is not be overwritten or versioned.

18. An apparatus for deploying content from a source to a destination, the apparatus comprising:
means for populating an export table during a first deployment mode with references to:
one or more content items to be deployed,
children, if any, of the one or more content items, and
dependencies of the one or more content items and children;
means for getting content items from a content database corresponding to the references stored in the export table; and
means for formatting data of the content items.

19. The apparatus of claim 18 further comprising means for determining, for each content item to be deployed, whether the content item was changed since the last time the content item was deployed to the destination.

20. The apparatus of claim 18 wherein the means for formatting data of the content items comprises means for serializing the content items.
